(19) United States
(12) Patent Application Publication
(10) Pub. No.: US 2010/0275270 A1
(43) Pub. Date: Oct. 28, 2010

(54) METHOD AND APPARATUS FOR MANAGING THE TRANSFER OF RIGHTS

(75) Inventors: Xin WANG, Torrance, CA (US); Thanh Ta, Huntington Beach, CA (US); Guillermo Lao, Torrance, CA (US); Eddie J. Chen, Rancho Palos Verdes, CA (US)

Correspondence Address: NIXON PEABODY, LLP, 401 9TH STREET, NW, SUITE 900, WASHINGTON, DC, 20004-2128, US

(73) Assignee: ContentGuard Holdings, Inc., Wilmington, DE (US)

(21) Appl. No.: 12/831,535

(22) Filed: Jul. 7, 2010

Related U.S. Application Data
(63) Continuation of application No. 10/162,701, filed on Jun. 6, 2002.
(60) Provisional application No. 60/331,624, filed on Nov. 20, 2001.
(60) Provisional application No. 60/331,623, filed on Nov. 20, 2001.
(60) Provisional application No. 60/331,621, filed on Nov. 20, 2001.
(60) Provisional application No. 60/296,113, filed on Jun. 7, 2001.
(60) Provisional application No. 60/296,117, filed on Jun. 7, 2001.
(60) Provisional application No. 60/296,118, filed on Jun. 7, 2001.

(51) Int. Cl. G06F 21/24

(52) U.S. Cl. 726/28

(57) ABSTRACT

A method and apparatus for managing the transfer of rights associated with items from a rights supplier to a rights consumer. A set of rights is associated with an item and includes meta-rights specifying derivable rights that can be derived therefrom by the rights consumer. The set of rights is transferred, in the form of a license to the item, from the rights supplier to the rights consumer. If it is determined that the rights consumer is entitled to derive the derivable rights specified by the meta-rights, the derivable rights are derived and a license including the derived rights is generated with the rights consumer designated as a principal.

### RELATED APPLICATION DATA

This application is a continuation of U.S. patent application Ser. No. 10/162,701, filed Jun. 6, 2002, which claims benefit from U.S. Provisional Applications Ser. Nos. 60/331,624, 60/331,623, and 60/331,621, filed on Nov. 20, 2001, and U.S. Provisional Applications Ser. Nos. 60/296,113, 60/296,117, and 60/296,118, filed on Jun. 7, 2001, the disclosures of which are hereby incorporated herein by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

One of the most important issues impeding the widespread distribution of digital works (i.e. documents or other content in forms readable by computers), via electronic means, and the Internet in particular, is the current lack of ability to enforce the intellectual property rights of content owners during the distribution and use of digital works. Efforts to resolve this problem have been termed “Intellectual Property Rights Management” (“IPRM”), “Digital Property Rights Management” (“DPRM”), “Intellectual Property Management” (“IPM”), “Rights Management” (“RM”), and “Electronic Copyright Management” (“ECM”), collectively referred to as “Digital Rights Management (DRM)” herein. There are a number of issues to be considered in effecting a DRM System. For example, authentication, authorization, accounting, payment and financial clearing, rights specification, rights verification, rights enforcement, and document protection issues should be addressed. U.S. Pat. Nos. 5,530,235, 5,634,012, 5,715,403, 5,638,443, and 5,629,980, the disclosures of which are incorporated herein by reference, disclose DRM systems addressing these issues.

Two basic DRM schemes have been employed, secure containers and trusted systems. A “secure container” (or simply an encrypted document) offers a way to keep document contents encrypted until a set of authorization conditions are met and some copyright terms are honored (e.g., payment for use). After the various conditions and terms are verified with the document provider, the document is released to the user in clear form. Commercial products such as CRYPTOLOPES™ and DIGIBOXES™ fall into this category. Clearly, the secure container approach provides a solution to protecting the document during delivery over insecure channels, but does not provide any mechanism to prevent legitimate users from obtaining the clear document and then using and redistributing it in violation of content owners' intellectual property.

In the “trusted system” approach, the entire system is responsible for preventing unauthorized use and distribution of the document. Building a trusted system usually entails introducing new hardware such as a secure processor, secure storage and secure rendering devices. This also requires that all software applications that run on trusted systems be certified to be trusted. While building tamper-proof trusted systems is a real challenge to existing technologies, current market trends suggest that open and untrusted systems, such as PC's and workstations using browsers to access the Web, will be the dominant systems used to access digital works. In this sense, existing computing environments such as PC's and workstations equipped with popular operating systems (e.g., Windows™, Linux™, and UNIX) and rendering applications, such as browsers, are not trusted systems and cannot be made trusted without significantly altering their architectures. Of course, alteration of the architecture defeats a primary purpose of the Web, i.e. flexibility and compatibility.

As an example, U.S. Pat. No. 5,634,012, the disclosure of which is incorporated herein by reference, discloses a system for controlling the distribution of digital documents. Each rendering device has a repository associated therewith. A predetermined set of usage transaction steps define a protocol used by the repositories for enforcing usage rights. Usage rights define one or more manners of use of the associated document content and persist with the document content. The usage rights can permit various manners of use such as, viewing only, use once, distribution, and the like. Usage rights can be contingent on payment or other conditions. Further, a party may grant usage rights to others that are a subset of usage rights possessed by the party.

DRM systems have facilitated distribution of digital content by permitting the content owner to control use of the content. However, known business models for creating, distributing, and using digital content and other items involve a plurality of parties. For example, a content creator may sell content to a publisher who then authorizes a distributor to distribute content to an on-line storefront who then sells content to end-users. Further, the end users may desire to share or further distribute the content. In such a business model, usage rights can be given to each party in accordance with their role in the distribution chain. However, the parties do not have control over downstream parties unless they are privy to any transaction with the downstream parties in some way. For example, once the publisher noted above provides content to the distributor, the publisher cannot readily control rights granted to downstream parties, such as the first or subsequent users unless the publisher remains a party to the downstream transaction. This loss of control combined with the ever increasing complexity of distribution chains results in a situation, which hinders the distribution of digital content and other items. Further, the publisher may want to prohibit the distributor and/or the storefront from viewing or printing content while allowing an end user receiving a license from the storefront to view and print. Accordingly, the concept of simply granting rights to others that are a subset of possessed rights is not adequate for multi-party, i.e. multi-tier, distribution models.

### SUMMARY OF THE INVENTION

A first aspect of the invention is a method for transferring rights adapted to be associated with items from a rights supplier to a rights consumer. The method comprises obtaining a set of rights associated with an item, said set of rights including meta-rights specifying derivable rights that can be derived therefrom by the rights consumer, and determining whether the rights consumer is entitled to derive the derivable rights specified by the meta-rights, and at least one of deriving the derivable rights, and generating a license including the derived rights with the rights consumer designated as a principal if the rights consumer is entitled to derive the derivable rights specified by the meta-rights.

A second aspect of the invention is a license associated with an item and adapted to be used within a system for managing the transfer of rights to the item from a rights supplier to a rights consumer. The license comprises a set of rights including meta-rights specifying derivable rights that can be derived therefrom by the rights consumer, a principal designating at least one rights consumer who is authorized to derive the derivable rights, and a mechanism for providing access to the item in accordance with the set of rights.

A third aspect of the invention is a method for deriving rights adapted to be associated with items from meta-rights. The method comprises obtaining a set of rights associated with an item, said set of rights including meta-rights specifying derivable rights that can be derived therefrom by the rights consumer, and generating a license associated with said item and including the derived rights.

### BRIEF DESCRIPTION OF THE DRAWING

The invention will be described through a preferred embodiment and the attached drawing in which:

FIG. 1 is a schematic illustration of a rights management system in accordance with the preferred embodiment;

FIG. 2 is a block diagram of an example distribution chain showing the derivation of rights from meta-rights;

FIG. 3 is a schematic illustration of a license in accordance with the preferred embodiment;

FIG. 4 is an example of a license expressed with an XML based rights language in accordance with the preferred embodiment;

FIG. 5 is a block diagram of the license server of the system of FIG. 1;

FIG. 6 is a block diagram of a rights label in accordance with the preferred embodiment; and

FIG. 7 is a flow chart of the procedure for transferring and deriving rights in accordance with the preferred embodiment.

### DETAILED DESCRIPTION

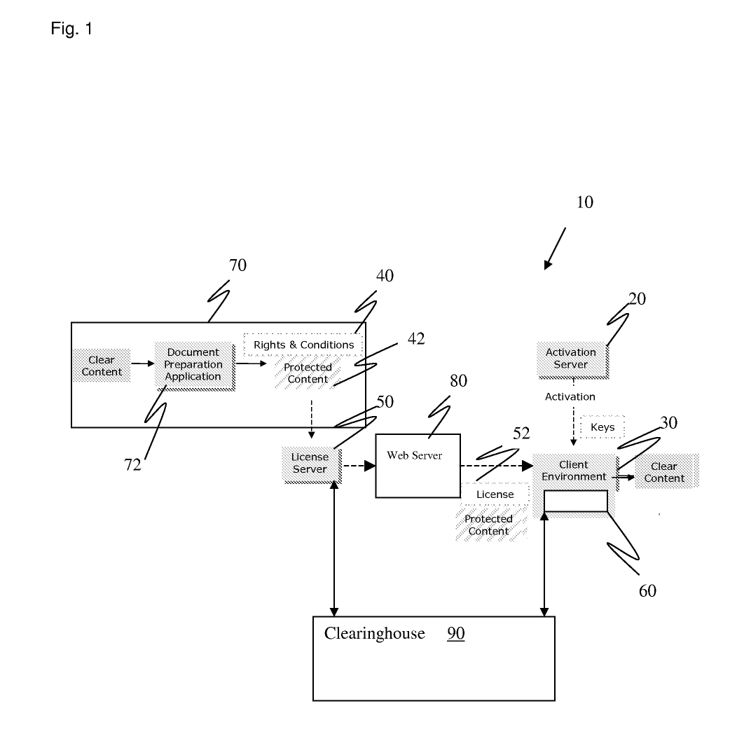

A DRM system can be utilized to specify and enforce usage rights for specific content, services, or other items. FIG. 1 illustrates DRM System 10 that can be used in connection with the preferred embodiment. DRM System 10 includes a user activation component, in the form of activation server 20, that issues public and private key pairs to content users in a protected fashion, as is well known. During an activation process, some information is exchanged between activation server 20 and client environment 30, a computer or other device associated with a content recipient, and client component 60 is downloaded and installed in client environment 30. Client component 60 preferably is tamper resistant and contains the set of public and private keys issued by activation server 20 as well as other components, such as any component necessary for rendering content 42.

Rights label 40 is associated with content 42 and specifies usage rights and possibly corresponding conditions that can be selected by a content recipient. License Server 50 manages the encryption keys and issues licenses for protected content. These licenses embody the actual granting of usage rights to an end user. For example, rights label 40 may include usage rights permitting a recipient to view content for a fee of five dollars and view and print content for a fee of ten dollars. License 52 can be issued for the view right when the five dollar fee has been paid, for example. Client component 60 interprets and enforces the rights that have been specified in license 52.

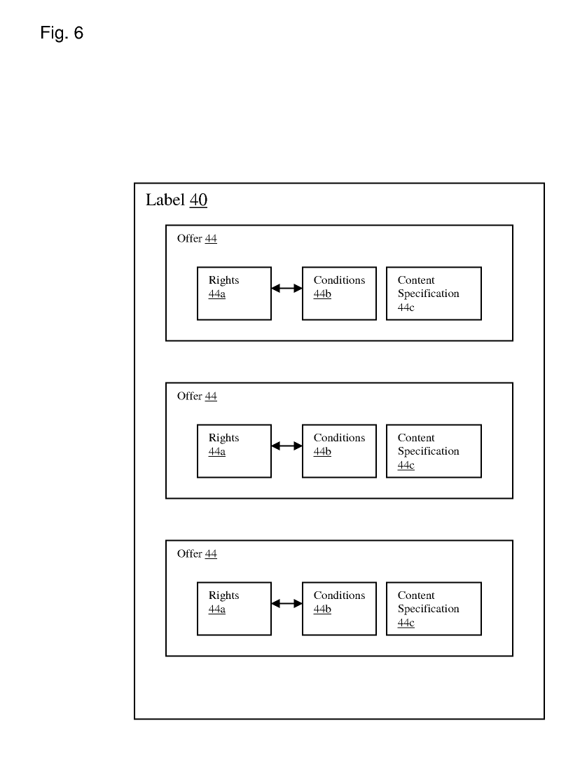

FIG. 6 illustrates rights label 40 in accordance with the preferred embodiment. Rights label 40 includes plural rights offers 44 each including usage rights 44a, conditions 44b, and content specification 44c. Content specification 44c can include any mechanism for calling, referencing, locating, linking or otherwise specifying content 42 associated with offer 44. Clear (unprotected) content can be prepared with document preparation application 72 installed on computer 70 associated with a content publisher, a content distributor, a content service provider, or any other party. Preparation of content consists of specifying the rights and conditions under which content 42 can be used, associating rights label 40 with content 42 and protecting content 42 with some crypto algorithm. A rights language such as XrML™ can be used to specify the rights and conditions. However, the rights can be specified in any manner. Also, the rights can be in the form of a pre-defined specification or template that is merely associated with the content. Accordingly, the process of specifying rights refers to any process for associating rights with content. Rights label 40 associated with content 42 and the encryption key used to encrypt the content can be transmitted to license server 50. As discussed in detail below, rights 44a can include usage rights, which specify a manner of use, and meta-rights, which permit other rights to be derived.

In some case, license 52 includes conditions that must be satisfied in order to exercise a specified right. For, example a condition may be the payment of a fee, submission of personal data, or any other requirement desired before permitting exercise of a manner of use. Conditions can also be “access conditions” for example, access conditions can apply to a particular group of users, say students in a university, or members of a book club. In other words, the condition is that the user is a particular person or member of a particular group. Rights and conditions can exist as separate entities or can be combined.

Labels, offers, usage rights, and conditions can be stored together with content 42 or otherwise associated with content 42 through content specification 44c or any other mechanism. A rights language such as XrML™ can be used to specify the rights and conditions. However, the rights can be specified in any manner. Also, the rights can be in the form of a pre-defined specification or template that is merely associated with content 42.

A typical workflow for DRM system 10 is described below. A recipient operating within client environment 30 is activated for receiving content 42 by activation server 20. This results in a public-private key pair (and possibly some user/machine specific information) being downloaded to client environment 30 in the form of client software component 60 in a known manner. This activation process can be accomplished at any time prior to the issuing of a license.

When a recipient wishes to obtain specific content 42, the recipient makes a request for content 42. For example, a user, as a recipient, might browse a Web site running on Web server 80, using a browser installed in client environment 30, and request content 42. During this process, the user may go through a series of steps possibly including a fee transaction (as in the sale of content) or other transactions (such as collection of information). When the appropriate conditions and other prerequisites, such as the collection of a fee and verification that the user has been activated, are satisfied, Web server 80 contacts license server 50 through a secure communications channel, such as a channel using a Secure Sockets Layer (SSL). License server 50 then generates license 52 for content 42 and Web server 80 causes both the content and license 52 to be downloaded. License 52 includes the appropriate rights, such as usage rights and/or meta-rights, and can be downloaded from license server 50 or an associated device. Content 42 can be downloaded from computer 70 associated with a vendor, distributor, or other party.

Client component 60 in client environment 30 will then proceed to interpret license 52 and allow use of content 42 based on the usage rights and conditions specified in license 52. The interpretation and enforcement of usage rights are well known generally and described in the patents referenced above, for example. The steps described above may take place sequentially or approximately simultaneously or in various orders.

DRM system 10 addresses security aspects of content 42. In particular, DRM system 10 may authenticate license 52 that has been issued by license server 50. One way to accomplish such authentication is for application 60 to determine if license 52 can be trusted. In other words, application 60 has the capability to verify and validate the cryptographic signature, or other identifying characteristic of license 52. Of course, the example above is merely one way to effect a DRM system. For example, license 52 and content 42 can be distributed from different entities. Clearinghouse 90 can be used to process payment transactions and verify payment prior to issuing a license.

As noted above, typical business models for distributing digital content include plural parties, such as owners, publishers, distributors, and users. Each of these parties can act as a supplier granting rights to a consumer downstream in the distribution channel. The preferred embodiment extends the known concepts of usage rights, such as the usage rights and related systems disclosed in U.S. Pat. Nos. 5,629,980, 5,634,012, 5,638,443, 5,715,403 and 5,630,235, to incorporate the concept of “meta-rights.” Meta-rights are the rights that one has to generate, manipulate, modify, dispose of or otherwise derive other rights. Meta-rights can be thought of as usage rights to usage rights (or other meta-rights). This concept will become clear based on the description below.

Meta-rights can include derivable rights to offer rights, grant rights, negotiate rights, obtain rights, transfer rights, delegate rights, expose rights, archive rights, compile rights, track rights, surrender rights, exchange rights, and revoke rights to/from others. Meta-rights can include the rights to modify any of the conditions associated with other rights. For example, a meta-right may be the right to extend or reduce the scope of a particular right. A meta-right may also be the right to extend or reduce the validation period of a right. Meta-rights can be hierarchical and can be structured as objects within objects. For example, a distributor may have a meta-right permitting the distributor to grant a meta-right to a retailer which permits the retailer to grant users rights to view content. Just as rights can have conditions, meta-rights can also have conditions. Meta-rights can also be associated with other meta-rights.

The concept of meta-rights can be particularly useful because distribution models may include entities that are not creators or owners of digital content, but are in the business of manipulating the rights associated with the content. For example, as noted above, in a multi-tier content distribution model, intermediate entities (e.g., distributors) typically will not create or use the content but will be given the right to issue rights for the content they distribute. In other words, the distributor or reseller will need to obtain rights (meta-rights) to issue rights. For the sake of clarity, the party granting usage rights or meta-rights is referred to as “supplier” and the party receiving and/or exercising such rights is referred to as “consumer” herein. It will become clear that any party can be a supplier or a consumer depending on their relationship with the adjacent party in the distribution chain. Note that a consumer “consumes”, i.e. exercises, rights and does not necessarily consume, i.e. use, the associated content.

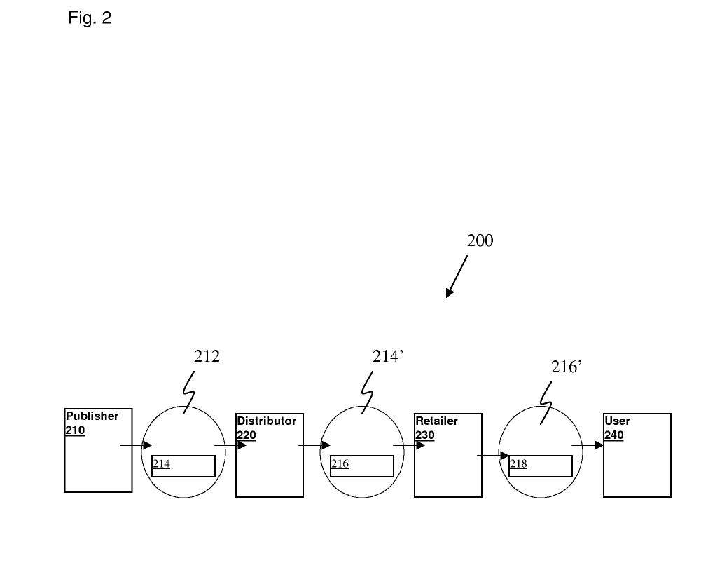

FIG. 2 schematically illustrates an example of a multi-tier distribution model 200. Publisher 210 publishes content for distribution, by distributor 220 for example. Distributor 220 distributes content to retailers, such as retailer 230 and retailer 230 sells content to users, such as user 240. In model 200, publisher 210 could negotiate business relationships with distributor 220 and distributor 220 could negotiate business relationships with retailer 230. Also, retailer 230 may desire usage rights that are beyond usage rights granted to distributor 220. However, keep in mind that, in a distribution chain that utilizes a DRM system to control use and distribution of content or other items, content can travel from publisher 210 to user 240 through any digital communication channel, such a network or transfer of physical media. When user 240 wishes to use content, a license is obtained, in the manner described above for example. Accordingly, the negotiated relationships can become difficult, if not impossible, to manage.

In model 200 of FIG. 2, retailer 230 will only grant rights to user 240 that have been predetermined and authorized by the distributor 220, publisher 210 and potentially other parties upstream of the transaction, such as the content creator or owner. The rights are predetermined through, and derived from, meta-rights granted to retailer 230 by distributor 220. Of course, there can be any number of parties in the distribution chain. For example, distributor 220 may sell directly to the public in which case retailer 230 is not necessary. Also, there may be additional parties. For example user 240 can distribute to other users.

In model 200 publisher grants to distributor 220 usage rights 212 permitting distribution of content, and meta-rights 214. Meta-rights 214 permit distributor 220 to grant to retailer 230 the usage right 214′ (derived from meta-rights 214) to distribute or possibly sell content and meta-rights 216 which permit retailer 230 to grant user 240 the right to use content. For example, publisher 210 may specify, through meta-rights 214, that meta-right 216 granted to retailer 230 permits retailer 230 to grant only 500 licenses and usage rights 216′ that retailer 230 can grant to a user can only be “view” and “print-once”. In other words, distributor 220 has granted meta-rights to retailer 230. Similarly, publisher 210 issues meta-rights 214 to the distributor that will govern what type, and how many, rights distributor 220 can grant to retailer 230. Note that these entities could be divisions, units or persons that are part of a larger enterprise, which also has other roles. For example, an enterprise might create, distribute, and sell content and carry out those activities using different personnel or different business units within the enterprise. The principles of meta-rights can be applied to an enterprise to determine content usage within that enterprise. Also, retailer 230 could grant meta-rights 218 to user 240 permitting user 240 to share rights or grant usage rights to achieve a super-distribution model. It can be seen that meta-rights of a party are derived from meta-rights granted by an upstream party in the distribution chain.

For example, a person's medical records can be in digital form managed by a first hospital as publisher 230. In this scenario, the person, as supplier, grants usage rights to the hospital, as consumer, to access and update the medical records. Should that person require treatment at a second hospital and desires to transfer their records to the second hospital, the person can grant to the first hospital the right to transfer the access rights to the new hospital through meta-rights. In other words, the person has specified meta-rights and granted the meta-rights to the first hospital. The meta-rights permit the first hospital to grant rights, as a supplier, to the second hospital, as a consumer. In another example, a person's last will and testament can be in digital form and managed by a law firm as publisher 210. If the person wishes to allow a third party to review the will. The person can grant meta-rights to the law firm permitting the law firm to grant access rights to this third party.

At a high level the process of enforcing and exercising meta-rights are the same as for usage rights. However, the difference between usage rights and meta-rights are the result from exercising the rights. When exercising usage rights, actions to content result. For example usage rights can be for viewing, printing, or copying digital content. When meta-rights are exercised, new rights are created from the meta-rights or existing rights are disposed as the result of exercising the meta-rights. The recipient of the new rights may be the same principal (same person, entity, or machine, etc), who exercises the meta-rights. Alternatively, the recipient of meta-rights can be a new principal. The principals who receive the derived rights may be authenticated and authorized before receiving/storing the derived rights. Thus, the mechanism for exercising and enforcing a meta-right can be the same as that for a usage right. For example, the mechanism disclosed in U.S. Pat. No. 5,634,012 can be used.

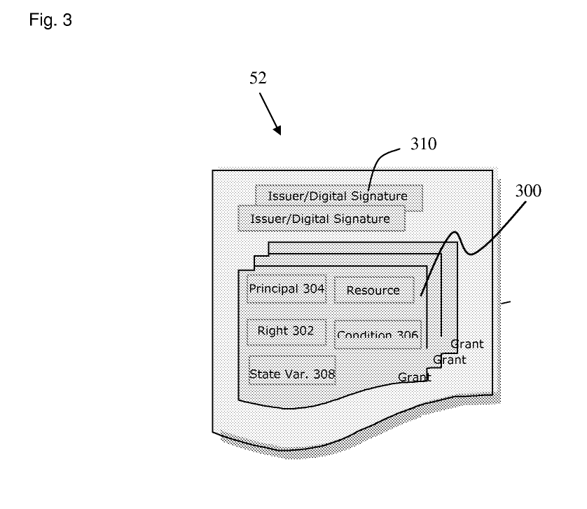

Meta-rights can be expressed by use of a grammar or rights language including data structures, symbols, elements, or sets of rules. For example, the XrML™ rights language can be used. As illustrated in FIG. 3, the structure of license 52 can consist of one or more grants 300 and one or more digital signatures 310. Each grant 300 includes specific granted meta-rights 302 such as rights to offer usage rights, grant usage rights, obtain usage rights, transfer usage rights, exchange usage rights, transport usage rights, surrender usage rights, revoke usage rights, reuse usage rights, or management meta-rights such as the rights to backup rights, restore rights, recover rights, reissue rights, or escrow the rights for management of meta-rights and the like.

Grant 300 can also specify one or more principals 304 to whom the specified meta-rights are granted. Also grants 300 can include conditions 306 and state variables 308. Like usage rights, access and exercise of the granted meta-rights are controlled by any related conditions 306 and state variables 308. The integrity of license 52 is ensured by the use of digital signature 310, or another identification mechanism. Signature 310 can include a crypto-algorithm, a key, or another mechanism for providing access to content 42 in a known manner. The structure of digital signature 310 includes the signature itself, the method of how the code is computed, the key information needed to verify the code and issuer identification.

State variables track potentially dynamic states conditions. State variables are variables having values that represent status of rights, or other dynamic conditions. State variables can be tracked, by clearinghouse 90 or another device, based on identification mechanisms in license 52. Further, the value of state variables can be used in a condition. For example, a usage right can be the right to print content 42 for and a condition can be that the usage right can be exercised three times. Each time the usage right is exercised, the value of the state variable is incremented. In this example, when the value of the state variable is three, the condition is no longer satisfied and content 42 cannot be printed. Another example of a state variable is time. A condition of license 52 may require that content 42 is printed within thirty days. A state variable can be used to track the expiration of thirty days. Further, the state of a right can be tracked as a collection of state variables. The collection of the change is the state of a usage right represents the usage history of that right.

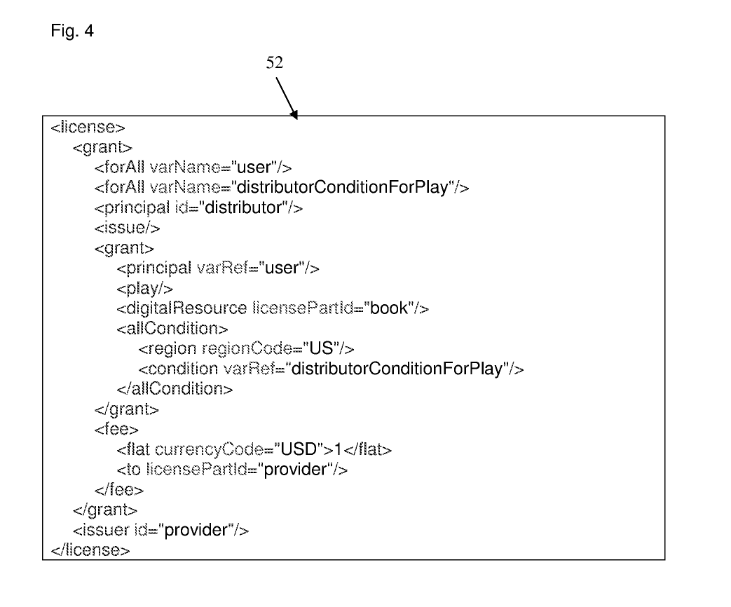

FIG. 4 is an example of license 52 encoded in XrML™. The provider grants the distributor a meta right to issue a usage right (i.e., play) to the content (i.e., a book) to any end user. With this meta right, the distributor may issue the right to play the book within the U.S. region and subject to some additional conditions that the distributor may impose upon the user, as long as the distributor pays $1 to the provider each time the distributor issues a license for an end user. The XrML™ specification is published and thus well known.

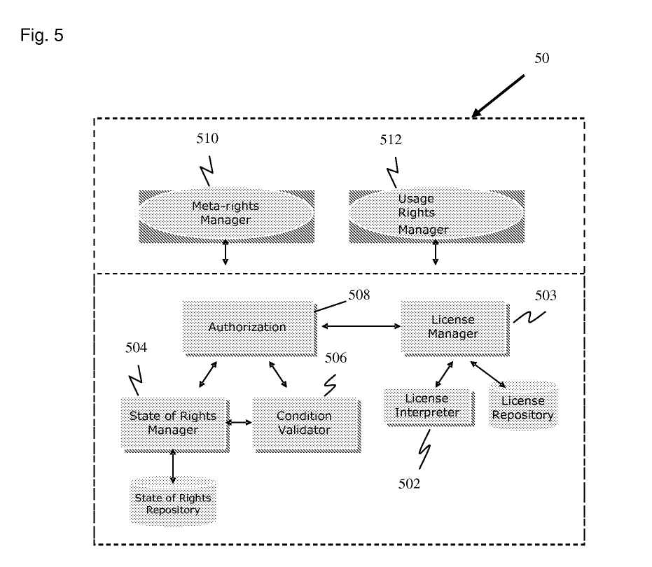

FIG. 5 illustrates the primary modules of license server 50 in accordance with the preferred embodiment. License interpreter module 502 validates and interprets license 52 and also provides the functions to query any or all fields in the license such as meta—rights 302, conditions 306, state variables 308, principle 304, and/or digital signature 310. License manager module 503 manages all license repositories for storing licenses 52, and also provides functions to create licenses 52 for derived rights, verify licenses, store licenses, retrieve licenses and transfer licenses. State of rights module 504 manages the state and history of rights and meta-rights. The current value and history of the state variables together with the conditions controls the permission to exercise given meta-rights for a given authenticated principal. Condition validator 506 verifies conditions associated with the meta-rights. Together with the state variables, conditions associated with meta-rights define variables whose values may change over the lifetime of the meta-rights. Values of state variables used in conditions can affect the meta-rights at the time and during the time the rights are exercised.

Authorization module 508 authorizes the request to exercise meta-rights and to store the newly created rights or derived rights as the result of exercising the meta-rights. Authorization module 508 accesses both state of rights manager module 504 and condition validator module 506. Authorization module 508 interacts with license manager module 503 and the list of state variables and conditions and then passes the state variables to state of rights manager module 504 and condition list to condition validator module 506 for authorization.

A request for exercising a meta-right is passed to meta-rights manager module 510. Assuming that the requesting device has been authenticated, meta-rights manager module 510 requests the license manager module 504 to verify the license for exercising the requested meta-rights. License manager module 504 verifies the digital signature of the license and the key of the signer. If the key of the signer is trusted and the digital signature is verified then license manager module 504 returns “verified” to the meta-rights manager module 510. Otherwise “not verified” is returned.

Authorization module 508 instructs license manager 503 to fetch state variable 308 and conditions 306 of license 52. Authorization manager 508 then determines which state variables are required to enforce to enforce license 52. State of rights manager 504 then supplies the current value of each required state variable to authorization module 508. Authorization module 508 then passes conditions 306 and the required state variables to condition validator 506. If all conditions 306 are satisfied, authorization module 508 returns “authorized” to meta-rights manager module 510.

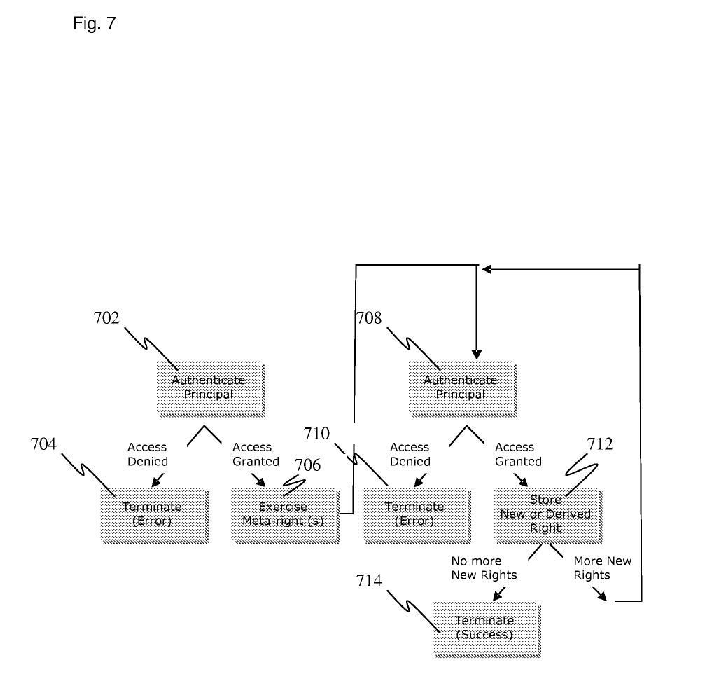

Meta-rights manager module 510 verifies license 52 and meta-rights 302 therein, to authorize the request to exercise meta-rights 302, to derive new rights from meta-rights 302, and to update the state of rights and the current value of the conditions. Rights manager module 512, on the other hand, manages the new rights created or the derived rights as the result of exercising the meta-rights. Rights manager module 512 uses authorization module 508 to verify that recipient of the newly created rights or derived rights is intended principal 304. If the recipient are authorized then the rights manager module 512 directs license manager 504 to store the newly created rights in a repository associated with the consumer. This is discussed in greater detail below with reference to FIG. 7.

The authorization process is not limited to the sequence or steps described above. For example, a system could be programmed to allow authorization module 508 to request the state conditions from license manager 504 prior to verification of the digital signature. In such a case it would be possible to proceed subject to a verified license. Further, the various modules need not reside in the license server or related devices. The modules can be effected through hardware and/or software in any part of the system and can be combined or segregated in any manner.

Once a request to exercise a meta-rights has been authorized, the meta-right can be exercised. Meta-rights manager module 510 informs state of rights module 504 that it has started exercising the requested meta-rights. State of rights module 504 then records the usage history and changes its current value of the state variables. Meta-rights manager module 510 exercises the requested meta-rights in a manner similar to known procedures for usage rights. If new rights are derived, then meta-rights manager module 510 invokes license manager module 504 to create new rights as the result of exercising the target meta-rights. Each new right is then sent to the corresponding rights manager module 512 of the consumer and stored in a repository associated with the consumer. Rights manager module 512 of the consumer will authenticate and authorize the consumer before receiving and storing the newly created right. New rights can be derived from meta-rights in accordance with a set of rules or other logic. For example, one rule can dictate that a consumed right to offer a license for use will result in the consumer having the right to offer a usage right and grant a license to that usage right to another consumer.

FIG. 7 illustrates the workflow for transferring meta-rights and deriving new rights from the meta-rights in accordance with the preferred embodiment. All steps on the left side of FIG. 7 relate to the supplier of rights and all steps on the right side of FIG. 7 relate to the consumer of rights. In step 702, principal 304 of license 52 is authenticated in a known manner. In other words, it is determined if the party exercising meta-right 302 has the appropriate license to do so. If the principal is not authorized, the procedure terminates in step 704. If the principal is authorized, the procedures advances to step 706 in which meta right 302 is exercised and transmitted to the consumer in the form of license 52 having derived rights in the manner set forth above. In step 708 the principal of this new license is authenticated. In other words, it is determined if the party exercising the derived rights has the appropriate license to do so. If the principal is not authorized, the procedure terminates in step 710. If the principal is authorized, the procedures advances to step 712 in which the derived right is stored. The procedure then returns to step 708 for each additional right in the license and terminates in step 714 when all rights have been processed.

The preferred embodiments is not limited to situations where resellers, distributors or other “middlemen” are used. For example, the preferred embodiment can be applied within enterprises or other organizations, which create and/or distribute digital content or other items to control use of the content within the enterprise or other organization. Meta-rights can also be issued to end-users, when the grant of a right relates to another right. For example, the right to buy or sell securities as it is in the case of trading options and futures. Meta-rights can be assigned or associated with goods services, resources, or other items.

The invention can be implemented through any type of devices, such as computers and computer systems. The preferred embodiment is implemented in a client server environment. However, the invention can be implemented on a single computer or other device. Over a network using dumb terminals, thin clients, or the like, or through any configuration of devices. The various modules of the preferred embodiment have been segregated and described by function for clarity. However, the various functions can be accomplished in any manner through hardware and/or software. The various modules and components of the preferred embodiment have separate utility and can exist as distinct entities. Various communication channels can be used with the invention. For example, the Internet or other network can be used. Also, data can be transferred by moving media, such as a CD, DVD, memory stick or the like, between devices. Devices can include, personal computers, workstations, thin clients, PDA's and the like.

The invention has been described through a preferred embodiment. However, various modifications can be made without departing from the scope of the invention as defined by the appended claims and legal equivalents.

What is claimed:

1. A computer-implemented method for transferring rights associated with an item from a rights supplier to a rights consumer, the method comprising:
obtaining a set of rights associated with an item, the set of rights including a meta-right specifying one or more rights that can be created when the meta-right is exercised, wherein the meta-right is provided in digital form and is enforceable by a repository;
determining, by a repository, whether a rights consumer is entitled to at least one right of the one or more rights specified by the meta-right; and
exercising the meta-right to create the at least one right specified by the meta-right, if the rights consumer is determined to be entitled to the at least one right specified by the meta-right.

2. The method of claim 1, wherein the rights supplier is the same as the rights consumer.

3. The method of claim 1, wherein the set of rights further specifies at least one principal to whom the meta-right is granted.

4. The method of claim 3, wherein the exercising step is performed by the at least one specified principal.

5. The method of claim 1, wherein the created at least one right is a meta-right that permits the rights consumer to share rights with another rights consumer.

6. The method of claim 1, wherein the created at least one right is a right granting the rights consumer the right to offer a usage right to another rights consumer.

7. A system for transferring rights associated with an item from a rights supplier to a rights consumer, the system comprising:
a computing device configured to obtain a set of rights associated with an item, the set of rights including a meta-right specifying one or more rights that can be created when the meta-right is exercised, wherein the meta-right is provided in digital form and is enforceable by a repository;
a computing device configured to determine whether a rights consumer is entitled to at least one right of the one or more rights specified by the meta-right; and
a computing device configured to exercise the meta-right to create the at least one right specified by the meta-right.

8. The system of claim 7, wherein the rights supplier is the same as the rights consumer.

9. The system of claim 7, wherein the set of rights further specifies at least one principal to whom the meta-right is granted.

10. The system of claim 7, wherein the created at least one right includes a meta-right that permits the rights consumer to share rights with another rights consumer.

11. The system of claim 7, wherein the created at least one right is a right granting the rights consumer the right to offer a usage right to another rights consumer.

12. The system of claim 7, wherein two or more of the computing devices may be combined into a single computing device.

13. A device for transferring rights associated with an item from a rights supplier to a rights consumer, the device comprising:
a repository configured to obtain a set of rights associated with an item, the set of rights including a meta-right specifying one or more rights that can be created when the meta-right is exercised, wherein the meta-right is provided in digital form and is enforceable by a repository; and
a meta-rights manager module configured to determine whether a rights consumer is entitled to at least one right of the one or more rights specified by the meta-right, and exercise the meta-right to create the at least one right specified by the meta-right.

14. The device of claim 13, wherein the rights supplier is the same as the rights consumer.

15. The device of claim 13, wherein the set of rights further specifies at least one principal to whom the meta-right is granted.

16. The device of claim 13, wherein the created at least one right includes a meta-right that permits the rights consumer to share rights with another rights consumer.

17. The device of claim 13, wherein the created at least one right is a right granting the rights consumer the right to offer a usage right to another rights consumer.
